(19) United States
(12) Patent Application Publication
(10) Pub. No.: US 2025/0348781 A1
(43) Pub. Date: Nov. 13, 2025

(54) FEDERATED LOSS FUNCTIONS FOR BUILDING FOUNDATION MODELS VIA FEDERATED TRAINING

(71) Applicant: GE Precision Healthcare LLC, Waukesha, WI (US)

(72) Inventors: Hrithik Auchar, Bangalore (IN); Ananya Sahoo, Bangalore (IN)

(21) Appl. No.: 18/662,045

(22) Filed: May 13, 2024

(51) Int. Cl. G06N 20/00

(52) U.S. Cl. CPC G06N 20/00

(57) ABSTRACT

Systems or techniques that facilitate aggregation of models in the form of federated loss functions for building a central machine learning model via federated training are provided. In various embodiments, a system can aggregate at least one trained machine learning model in connection with a respective healthcare institution. In various aspects, the system can update parameters of a central machine learning model based on an optimization of a federated loss function computed from the at least one trained machine learning model, wherein the federated loss function comprises a federated error and a base loss. In various cases, the system can share the central machine learning model after updating the parameters based on the optimization of the federated loss function with the at least one trained machine learning model.

### TECHNICAL FIELD

The subject disclosure relates generally to a federated approach of learning natural language processing (NLP) foundation models, and more specifically to aggregation of foundation models collected from different organizations in the form of tailored loss functions for building foundation models via federated training.

### BACKGROUND

Foundation models are large, pre-trained artificial intelligence (AI) models that are trained on a diverse range of tasks and datasets to provide a basis for more specialized models to enable development of more advanced techniques and applications. Foundation models in Natural Language Processing (NLP) play crucial roles in understanding language structure, feature extraction, transfer learning, language modelling, natural language generation, and other NLP applications. Unfortunately, existing techniques for building healthcare foundation models pose concerns in data privacy and regulatory compliance. Accordingly, federated training of the foundation model can be employed to mitigate data privacy risks. Federated training is a machine learning approach where model training occurs via aggregating multiple locally trained devices or models. Unfortunately, existing techniques of aggregating local models for federated training of a foundation model affect performance of the foundation model and incur high computation costs to communicate between local devices and the foundation model.

Accordingly, systems or techniques that can address one or more of these technical problems can be desirable.

### SUMMARY

The following presents a summary to provide a basic understanding of one or more embodiments. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatus or computer program products that facilitate aggregation of models in the form of federated loss functions for building the central machine learning model via federated training are described.

According to one or more embodiments, a system is provided. The system can comprise a non-transitory computer-readable memory that can store computer-executable components. The system can further comprise a processor that can be operably coupled to the non-transitory computer-readable memory and that can execute the computer-executable components stored in the non-transitory computer-readable memory. In various embodiments, the computer-executable components can comprise a gathering component that can aggregate at least one trained machine learning model in connection with a respective healthcare institution. In various aspects, the computer-executable components can further comprise a training component that can update parameters of a central machine learning model based on an optimization of a federated loss function computed from the at least one trained machine learning model, wherein the federated loss function comprises a federated error and a base loss.

According to one or more embodiments, a computer-implemented method is provided. In various embodiments, the computer-implemented method can comprise aggregating, by a device operatively coupled to a processor, at least one trained machine learning model in connection with a respective healthcare institution. In various aspects, the computer-implemented method can comprise updating, by the device, parameters of a central machine learning model based on an optimization of a federated loss function computed from the at least one trained machine learning model, wherein the federated loss function comprises a federated error and a base loss.

According to one or more embodiments, a computer program product for facilitating aggregation of models in the form of federated loss functions for building the central machine learning model via federated training is provided. In various embodiments, the computer program product can comprise a non-transitory computer-readable memory having program instructions embodied therewith. In various aspects, the program instructions can be executable by a processor to cause the processor to aggregate at least one trained machine learning model in connection with a respective healthcare institution. In various instances, the program instructions can be further executable by the processor to cause the processor to update parameters of a central machine learning model based on an optimization of a federated loss function computed from the at least one trained machine learning model, wherein the federated loss function comprises a federated error and a base loss.

### DESCRIPTION OF THE DRAWINGS

FIG. 1 illustrates a block diagram of an example, non-limiting system that facilitates aggregation of models in the form of federated loss functions for building the central machine learning model via federated training accordance with one or more embodiments described herein.

FIG. 2 illustrates a block diagram of an example, non-limiting system including a network component that facilitates aggregation of models in the form of federated loss functions for building the central machine learning model via federated training in accordance with one or more embodiments described herein.

FIG. 3 illustrates an example, non-limiting block diagram that facilitates federated training of a central machine learning model in accordance with one or more embodiments described herein.

FIG. 4 illustrates an example, non-limiting block diagram that facilitates generating encodings based on an input sequence in accordance with one or more embodiments described herein.

FIG. 5 illustrates a block diagram of an example, non-limiting system including a scaling component that facilitates aggregation of models in the form of federated loss functions for building the central machine learning model via federated training in accordance with one or more embodiments described herein.

FIG. 6 illustrates an example, non-limiting block diagram that facilitates aggregation of models in the form of federated loss functions for building the central machine learning model via federated training in accordance with one or more embodiments described herein.

FIG. 7 illustrates an example, non-limiting block diagram that facilitates training of a central machine learning model in accordance with one or more embodiments described herein.

FIG. 8 illustrates a flow diagram of an example, non-limiting computer- implemented method that facilitates aggregation of models in the form of federated loss functions for building the central machine learning model via federated training in accordance with one or more embodiments described herein.

FIGS. 9A and 9B illustrate a flow diagram of an example, non-limiting computer- implemented method that facilitates aggregation of models in the form of federated loss functions for building the central machine learning model via federated training in accordance with one or more embodiments described herein.

FIG. 10 illustrates a block diagram of an example, non-limiting operating environment in which one or more embodiments described herein can be facilitated.

FIG. 11 illustrates an example networking environment operable to execute various implementations described herein.

### DESCRIPTION

The following detailed description is merely illustrative and is not intended to limit embodiments or application/uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Foundational healthcare models can be built or trained on datasets collected (e.g., web scraping from literature, news articles, and other pertinent data repositories) from various healthcare institutions (e.g., hospitals, medical research centers). In particular, a foundation model can be trained for Clinical Language Processing (CLP), which is a specialized field within natural language processing (NLP) that focuses on the development and application of computational methods to extract meaningful information from clinical texts. Such clinical texts can include electronic health records (EHRs), doctor's notes, pathology reports, radiology reports, and other healthcare-related documents. CLP enables computers to effectively analyze and interpret a vast amount of unstructured clinical text data generated in healthcare settings to improve various aspects of healthcare delivery (e.g., clinical decision support, research and clinical trials, quality improvement, patient safety, streamlining of billing or coding, population health management). However, such healthcare-related documents, records, or reports often contain sensitive patient data (e.g., names, dates of birth, addresses, social security numbers, medical histories, health conditions, medications, laboratory results, diagnostic imaging reports, treatments). Further, management of such data is subject to healthcare regulations (e.g., Health Insurance Portability and Accountability Act (HIPAA), General Data Protection Regulation (GDPR)) to enforce confidentiality and security.

To prevent disclosure of sensitive patient data, it can be desired to train the foundation model in a privacy-preserving manner. For instance, aggregating sensitive patient data into a centralized database can expose the sensitive patient data to unauthorized access, security risks, legal implications and/or various other privacy concerns. In particular, centralized sensitive patient data can become a target for cyber-attacks or data breaches. As another example, it can increase risk for misuse of the sensitive patient data, violating patient confidentiality. As yet another example, failure to strictly adhere to data protection laws, such as GDPR and HIPAA, when aggregating the data or training the foundation model on such data can result in legal consequences for healthcare organizations.

So, it can be desired to train the foundation model in a privacy-preserving manner. Existing techniques facilitate such training of the foundation model in a privacy-preserving manner by deidentifying all sensitive patient data before training the foundation model on such data. Patient data deidentification can involve removing or altering identifiable information to protect privacy while retaining the data's utility. In particular, direct identifiers (e.g., names, addresses, social security numbers) can be removed. Additionally, patient data deidentification can comprise generalizing or truncating indirect identifiers (e.g., dates of birth, zip codes) can be.

Unfortunately, such existing techniques are computationally intensive, time-consuming, and can impact a foundation model's performance. Indeed, the inventors of various embodiments described herein recognized that, because existing techniques rely upon deidentification of sensitive patient data that is centralized, such existing techniques can necessitate complex or resource intensive methods to perform deidentification of the sensitive patient data while balancing preservation of data utility with privacy protection requirements.

Additionally, existing techniques can impact the foundation model's ability to learn subtle patterns or nuances in the data due to a loss of granularity. For example, anonymizing patient data by removing direct identifiers (e.g., names, addresses) can result in a loss of context during training (e.g., a model trained on anonymized data with no patient names may not recognize recurring visits or treatment histories of individual patients, affecting personalized care recommendations). As another example, if patient data is generalized into broader categories (e.g. age ranges, geographic regions), the foundation model may be unable to differentiate between subtle variations within such categories (e.g., if patient ages are generalized into groups, the foundation model may overlook age-related nuances in disease progression or treatment responses). In any case, deidentifying data can reduce quality and specificity of the data needed for accurate model performance.

Further, unfortunately, existing techniques are still prone to reidentification risk. More specifically, even after deidentification, there is a potential risk of reidentification if external data sources are combined or if the deidentified data is linked with other information, compromising patient privacy and confidentiality. For instance, a healthcare organization can deidentify patient data but include geolocation information related to hospital visits. Accordingly, if the deidentified data is combined with a public dataset containing location details (e.g., transportation records, check-ins) when training the foundation model, it can be possible to identify individuals (e.g., if deidentified data shows a patient visiting a specific hospital on certain dates and a public transit dataset indicates a person with the same travel patterns, reidentification becomes feasible). As another example, data for training the foundation model can be combined with public information on company directories or professional profiles, which can enable individuals to be reidentified (e.g., a patient's unique identifier matched with their occupation as a rare specialist doctor in a specific area could lead to reidentification if there are limited professionals with similar profiles).

Moreover, challenges of handling data heterogeneity (e.g., inconsistency in data formats and structures across different sources, variations in terminology and coding standards between different healthcare systems, diversity of data types, such as text-based medical records, imaging data, and lab results) can impact adaptability of foundation models built using existing techniques. For example, one hospital can use a specific code or term for a medical condition, while another may use a different code or term for the same condition. Such disparity can lead to errors or inaccuracies in the foundation model's understanding and interpretation of the data. For instance, a foundation model trained on MRI data from one hospital may not perform well when applied to data from another hospital using different imaging protocols. As another example, a foundation model trained on a dataset from one region may not fully capture the diverse medical conditions and demographics of patients in another region. Additionally, data heterogeneity can be computationally complex and time-consuming. For example, different data types from different sources may require different preprocessing techniques or feature extraction methods, adding complexity to the training pipeline.

To preserve data privacy without deidentification, it can be desired to implement federated training of the foundation model. After local training of the local models, updates from the local models are aggregated to form a global model (e.g., foundation model, federated model). Unfortunately, existing techniques to implement federated training of models can face challenges from data heterogeneity (e.g., incompatible features or data representation, schema mismatches, varying levels of data quality, different model architectures feature selection) during aggregation of the multiple decentralized devices or servers. In various cases, differing volumes of training data between the multiple local models can cause a skewed foundation model that may not generalize sufficiently. For example, a local model trained on a larger dataset than another local model can generate more updates to the foundation model, causing bias in the foundation model towards patterns and characteristics present in training data of the local model trained on a larger dataset. Conversely, the local model trained on a smaller dataset may generate few updates, causing an underrepresentation of local patterns in the smaller dataset. In any case, such data imbalance can lead to inadequate capturing of diversity among the local models by the foundation model and cause data-dependent biases.

Accordingly, systems or techniques that can address one or more of these technical problems can be desirable.

Various embodiments described herein can address one or more of these technical problems. One or more embodiments described herein can include systems, computer-implemented methods, apparatus, or computer program products that can facilitate aggregation of models in the form of federated loss functions for building the central machine learning model via federated training. In particular, the inventors of various embodiments described herein devised various techniques that enable foundation models to be constructed by federated training using federated loss functions. More specifically, the present inventors realized that various shortcomings or disadvantages of existing techniques can be overcome by leveraging a federated loss function comprising a federated error that is computed from an error between output of the locally trained models (e.g., locally trained machine learning models) and the foundation model (e.g., a centralized machine learning model).

As described herein, the present inventors realized that a foundation model can be trained via federated training by aggregating trained machine learning models in connection with respective healthcare institutions to compute a federated loss, wherein the trained machine learning models are trained locally on data from the respective healthcare institutions. More specifically, the machine learning models can be trained on sensitive patient data without deidentifying such data, which can be used to compute an optimization of the federated loss for updating parameters of the central foundation model.

The present inventors realized that such federated loss can be utilized to more accurately or reliably facilitate foundation model building via federated training within healthcare applications. Indeed, at least one machine learning models can be locally trained with a respective healthcare institution, and a federated loss computed based on the at least one machine learning models can be leveraged to update parameters of the foundation model. Accordingly, when the parameters of the foundation model are updated based on the optimization of the federated loss, the updated foundation model can be shared with the healthcare institutions to improve accuracy or reliability of the locally trained machine learning models. Thus, accuracy of the foundation model and the one or more locally trained machine learning models can be improved while maintaining locality of sensitive patient data within the respective healthcare institutions.

Various embodiments described herein can be considered as a computerized tool (e.g., any suitable combination of computer-executable hardware or computer-executable software) that can facilitate aggregation of models in the form of federated loss functions for building the central machine learning model via federated training. In various aspects, such computerized tool can comprise a gathering component or a training component.

In various embodiments, the gathering component of the computerized tool can electronically access at least one trained machine learning model in connection with a respective healthcare institution. In various aspects, the gathering component can aggregate the at least one trained machine learning model from the respective healthcare institutions.

In various embodiments, the model component of the computerized tool can electronically store, maintain, control, or otherwise access a central machine learning model. In various aspects, the central machine learning model can exhibit any suitable NLP foundational model internal architecture. For example, the central machine learning can include any suitable numbers of any suitable types of layers (e.g., input layer, output layer, any of which can be convolutional layers, dense layers, long short-term memory (LSTM) layers, non-linearity layers, pooling layers, batch normalization layers, or padding layers) or any suitable number transformer encoder blocks. As another example, the central machine learning model can include any suitable numbers of neurons in various layers (e.g., different layers can have the same or different numbers of neurons as each other). As yet another example, the central machine learning model can include any suitable activation functions (e.g., softmax, sigmoid, hyperbolic tangent, rectified linear unit) in various neurons (e.g., different neurons can have the same or different activation functions as each other). As still another example, the LLM can include any suitable interneuron connections or interlayer connections (e.g., forward connections, skip connections, recurrent connections).

Regardless of its specific internal architecture, the central machine learning model can be configured as an NPL foundational model. That is, the central machine learning model can be configured to receive as input any suitable textual data (which, in various cases, may or may not be accompanied by any suitable numerical data or any suitable graphical data), and the central machine learning model can be configured to produce as output textual encodings (e.g., one or more synthesized sentences or sentence fragments) that is semantically or substantively based on such inputted textual data (and based on accompanying numerical or graphical data, as appropriate). In various aspects, the at least one machine learning model can be configured in a similar fashion. That is, the at least one machine learning models can be configured to receive as input any suitable textual data (which, in various cases, may or may not be accompanied by any suitable numerical data or any suitable graphical data), and the central machine learning model can be configured to produce as output textual encodings that is semantically or substantively based on such inputted textual data (and based on accompanying numerical or graphical data, as appropriate).

In various aspects, an encoding produced by the central machine learning model or the at least one machine learning model in response to a piece of inputted textual, numerical, or graphical data can be considered as any suitable mathematical quantity (e.g., scalar, vector, matrix, tensor, or any suitable combination thereof) that numerically represents at least some substantive or semantic aspect of that inputted textual, numerical, or graphical data in a low-dimensional fashion.

In various aspects, the training component can electronically leverage the encodings produced by the central machine learning model or the at least one machine learning model, so as to compute a federated loss.

More specifically, the training component can electronically execute the central machine learning model or the at least one machine learning model on the first natural language sentence. In various aspects, this can cause the central machine learning model or the at least one machine learning model to produce some synthesized text that is based on the first natural language sentence. That is, the training component can feed the first natural language sentence into the central machine learning model or the at least one machine learning model, the first natural language sentence can complete a forward pass through one or more transformer encoder blocks, and an output layer of the central machine learning model or the at least one machine learning model can compute the synthesized. In some instances, the synthesized text can be discarded, but the model component can extract or otherwise preserve the given encoding.

In various aspects, the model component can compute a base loss, by comparing the given encoding of the first natural language sentence to the encoding produced by the central machine learning model. In various cases, the model component can compute the federated loss, by comparing the encoding produced by the central machine learning model to the encoding produced by the at least one machine learning model. In various instances, the model component can perform such comparisons via any suitable error or similarity computation (e.g., mean absolute error (MAE), mean squared error (MSE), cross-entropy error, cosine similarity, Euclidean distance).

In any case, the training component can leverage embeddings produced by the central machine learning model or the at least one machine learning model, so as to compute an optimization of a federated loss function comprising the federated error and the base loss. Accordingly, the training component can update, via backpropagation, parameters of the central machine learning model.

In this way, the computerized tool can be considered as leveraging a federated loss based on encodings produced by the central machine learning model or the at least one machine learning model, so as to facilitate aggregation of models in the form of federated loss functions for building the central machine learning model via federated training.

Various embodiments described herein can be considered as being advantageous over existing techniques. Indeed, the present inventors realized that federated loss functions to build a foundation model via federated training can achieve decentralized model training on local datasets and improved performance of the foundation model. More specifically, the foundation model can be trained by determining a federated loss based on aggregating learnings of locally trained machine learning models. Accordingly, the foundation model trained using federated loss functions via federated training can mitigate risks of privacy and data breaches while maintain foundation model accuracy, whereas a foundation model built with existing techniques cannot be trained without deidentifying sensitive patient data to maintain foundation model performance. A foundation model trained via federated training can preserve data privacy without sacrificing operational efficiency by eliminating deidentification of sensitive data. The creation of a foundation model using federated loss functions via federated training can be far less time-consuming and effort-intensive than aggregating various datasets and deidentifying such data to train the foundation model, or than existing techniques of federated training.

Furthermore, the present inventors realized that federated loss functions to build a foundation model via federated training can mitigate data-dependent by weighting encodings generated by the at least one machine learning model based on their respective volumes of training data or geographic location of the respective healthcare institution. Thus, the foundation model can achieve better accuracy by accounting for imbalances in training data and enabling customization of the foundation model to geographic areas of interest for which the foundation model may be applied.

Moreover, the present inventors realized that iterative model enhancement can achieve a more robust or diversified foundation model per iteration by sharing the foundation model after updating based on the federated loss. Thus, the at least one machine learning models can be refined and re-aggregated for further enhancement of the foundation model.

Therefore, various embodiments described herein can be considered as a more efficient, risk averse, and effective way of building foundation models for healthcare applications, as compared to existing techniques.

Various embodiments described herein can be employed to use hardware or software to solve problems that are highly technical in nature (e.g., to facilitate aggregation of models in the form of federated loss functions for building the central machine learning model via federated training), that are not abstract and that cannot be performed as a set of mental acts by a human. Further, some of the processes performed can be performed by a specialized computer (e.g., training a machine learning model on medical reports) for carrying out defined acts related to foundation models. For example, such defined acts can include: aggregating, by a device operatively coupled to a processor, at least one trained machine learning model in connection with a respective healthcare institution; and updating, by the device, parameters of a foundation model based on a federated loss computed from the at least one trained machine learning model.

Such defined acts are not performed manually by humans. Indeed, neither the human mind nor a human with pen and paper can: electronically create a foundation model via federated training by training and aggregating local machine learning models. Indeed, foundation models are inherently-computerized, hardware-based, or software-based constructs that simply cannot be meaningfully implemented, trained, or executed in any way by the human mind without computers. A computerized tool that can automatically build a foundation model via federated learning and that can aggregate locally trained machine learning models is likewise inherently-computerized and cannot be implemented in any sensible, practical, or reasonable way without computers.

Moreover, various embodiments described herein can integrate into a practical application various teachings relating to building healthcare foundation models via federated training. Existing techniques build or construct foundation models by aggregating and centralizing various and extensive volumes of data. Unfortunately, as the present inventors recognized, foundation models built by such an approach can be considered as threatening data privacy with poor adaptability due to data heterogeneity. Accordingly, existing techniques require extensive deidentification of data and extensive use of data processing to reconcile disparate data representations. Such extensive deidentification of data and data processing can be considered as effort-intensive, time-consuming, or otherwise undesirable.

Various embodiments described herein can address one or more of these technical problems. In particular, the present inventors devised various techniques for constructing healthcare foundation models with federated loss functions (e.g., a federated loss) via federating training. Specifically, the present inventors recognized that foundation models built based on a federated loss can exhibit improved accuracy over conventional approaches when there is imbalanced data. Further, the present inventors recognized that foundation models built based on a federated loss can decrease computational resources needed for data sharing. Various embodiments described herein can include aggregating at least one trained machine learning model in connection with a respective healthcare institution. In various instances, the at least one trained machine learning model can be trained on sensitive healthcare data from the respective healthcare institution. Various embodiments described herein can further include updating parameters of a central machine learning model based on a federated loss computed from the at least one trained machine learning model, wherein the federated loss comprises a federated error and a base loss. In particular, the federated error can be computed based on, when given an input, a difference between an encoding of a prediction generated by the central machine learning model and one or more encodings of a prediction generated by the at least one trained machine learning model. In various aspects, the federated error can be weighted based on volume of training data of the at least one trained machine learning model or geographic locations of the respective healthcare institution. In various aspects, the central machine learning model can be shared after updating the parameters based on the federated loss with the at least one trained machine learning model. In various cases, this method can be iterated for further model improvement and refinement. By iteratively training the central machine learning model based on the federated loss, the central machine learning model can be constructed in a manner that overcomes problems previously described (e.g., less computation costs, less computation resources, data control, data privacy). Thus, various embodiments described herein can facilitate aggregation of models in the form of federated loss functions for building the central machine learning model via federated training. Because foundation models built based on a federated loss can exhibit improved accuracy with less computational resources, various embodiments described herein can be considered as an improved way of constructing foundation models, as compared to existing techniques. Accordingly, various embodiments described herein can be considered as a clever or inventive utilization of a federated loss so as to facilitate constructing foundation models. Thus, various embodiments described herein certainly constitute a tangible and concrete technical improvement or technical advantage in the field of foundation model training. Accordingly, such embodiments clearly qualify as useful and practical applications of computers.

Furthermore, various embodiments described herein can control real-world tangible devices based on the disclosed teachings. For example, various embodiments described herein can electronically train and execute real-world machine learning models, so as to build real-world foundation models that represent technical features or fabrication information about real-world healthcare institutions and real-world healthcare data.

It should be appreciated that the herein figures and description provide non-limiting examples of various embodiments and are not necessarily drawn to scale.

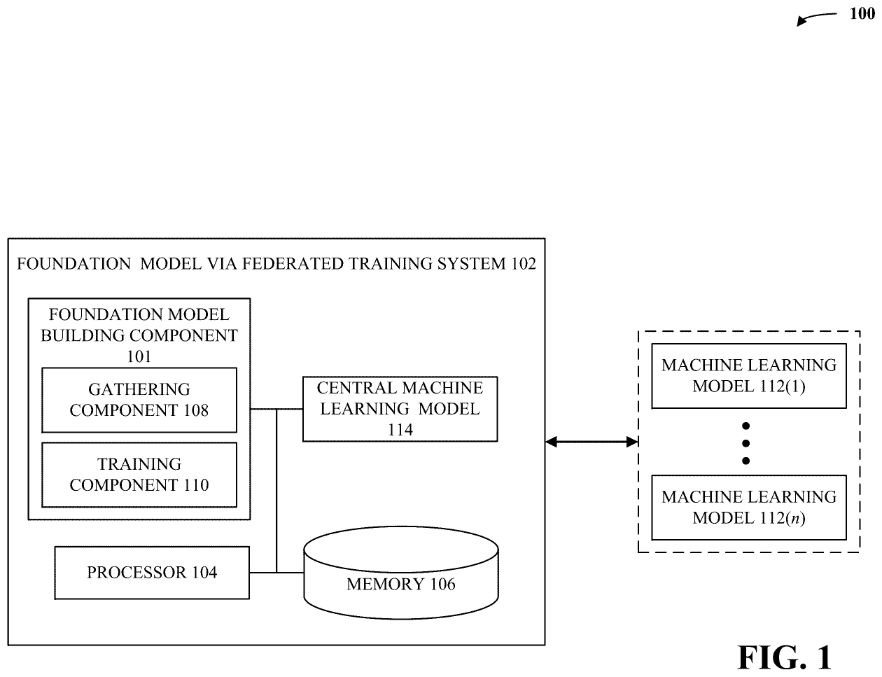

FIG. 1 illustrates a block diagram of an example, non-limiting system 100 that can facilitate aggregation of models in the form of federated loss functions for building the central machine learning model via federated training in accordance with one or more embodiments described herein. System 100 can include or correspond to one or more computing devices, machines, virtual machines, computer-executable components, datastores, and the like that may communicatively coupled to one another either directly or via one or more wired or wireless communication frameworks.

In various cases, machine learning models 112 can comprise n machine learning models, for any suitable positive integer n≥1: a machine learning model 112(1) to a machine learning model 112(n). In various aspects, the machine learning models 112 can be associated with a respective healthcare institution. In various cases, any suitable facility, institution, or organization that provides medical services, treatment, care, or is otherwise related to a medical field can be considered as the respective healthcare institutions, wherein the type of each of the respective healthcare institutions can differ among the machine learning models 112. As a non-limiting example, a healthcare institution can be a hospital, clinic, or health center. As another non-limiting example, a healthcare institution can be a medical research facility or diagnostic centers.

In any case, the machine learning models 112 can be locally trained on data collected from their respective healthcare institution. In various instances, the data collected from the respective healthcare institutions can comprise, but is not limited to, protected health information (PHI) reports, patient records, clinical text data (e.g., clinical notes), clinical trials data, medical literature, synthetic data, healthcare protocols, or any other suitable medical data. For example, the such data can comprise electronic health records (EHR) (e.g., patient demographics, medical histories, diagnoses, treatments, medication histories, laboratory results, imaging reports). As another example, such data can comprise clinical notes (e.g., objective findings, assessments, plans, medical observations). As yet another example, such data can comprise pathology reports (e.g., diagnostic findings, disease information, tumor information, tissue sample descriptions). As even another example, such data can comprise radiology reports (e.g., X-ray reports, MRI reports, CT reports, clinical impressions, abnormality reports). As still another example, such data can comprise medical literature such as research papers, journal articles, or textbooks. In any case, the machine learning models 112 can be trained on any data comprising relevant clinical textual information from the respective healthcare institution. In various instances, the machine learning models 112 can be trained on such data to execute CLP.

In various aspects, the machine learning models 112 can be locally trained on such data. More specifically, the machine learning models 112 can be trained on such data from their respective healthcare institution without sharing such data with other models or external entities (e.g., organizations or entities outside of the respective healthcare institution from which the machine learning model is being trained). For instance, machine learning model 112(1) in connection with a hospital can be trained exclusively on the hospital's own EHRs and patient data. Similarly, machine learning model 112(2) in connection with a research institute can undergo training exclusively on the research institute's collection of radiology reports and corresponding images. Such local training approach can mitigate violations of patient privacy and confidentiality, as well as allow the healthcare institutions to maintain control over their proprietary data to enforce compliance with healthcare regulations (e.g., HIPAA).

In various aspects, any suitable training methods to train the machine learning models 112 can be employed (e.g., supervised fashion, unsupervised fashion, reinforcement learning fashion). In some cases, the training methods employed to train the machine learning models 112 can differ between each of the machine learning models 112. For example, machine learning model 112(1) can be trained using supervised machine learning and machine learning model 112(2) can be trained using unsupervised machine learning.

In various embodiments, the foundation model via federated training system 102 can comprise a processor 104 (e.g., computer processing unit, microprocessor) and a non-transitory computer-readable memory 106 that is operably or operatively or communicatively connected or coupled to the processor 104. The non-transitory computer-readable memory 106 can store computer-executable instructions which, upon execution by the processor 104, can cause the processor 104 or other components of the foundation model via federated training system 102 (e.g., foundation model building component 101, gathering component 108, training component 110) to perform one or more acts. In various embodiments, the non-transitory computer-readable memory 106 can store computer-executable components (e.g., foundation model building component 101, gathering component 108, training component 110), and the processor 104 can execute the computer-executable components.

In various embodiments, the foundation model building component 101 can comprise sub-components (e.g., gathering component 108 and/or training component 110). In various aspects, the sub-components can be implemented independently without the other sub-components. In various cases, two or more of the sub-components can be combined into a single component.

In various embodiments, the foundation model via federated training system 102 can comprise gathering component 108. In various aspects, the gathering component 108 can electronically access the machine learning models 112. In various embodiments, the gathering component 108 can electronically access the machine learning models 112, such that the gathering component 108 can serve as a conduit through which other components of the foundation model via federated training system 102 can electronically interact with the machine learning models 112.

In various embodiments, the training component 110 can electronically store, electronically maintain, electronically control, or otherwise electronically access the central machine learning model 114. In various aspects, the central machine learning model 114 can have or otherwise exhibit any suitable internal architecture. For example, the central machine learning model 114 can comprise a transformer-based architecture. For instance, the central machine learning model 114 can exhibit a Bidirectional Encoder Representations from Transformers (BERT) model architecture, comprising input embeddings, one or more transformer encoder blocks, and an output layer. In various instances, the central machine learning model 114 can have segment embeddings to distinguish between different sentences or positional embeddings to encode positions of tokens in the embeddings. In various cases, the transformer encoder blocks can comprise a multi-head self-attention mechanism, a feed-forward neural network, normalization layers, and residual connections. In various cases, the output layer can comprise any number of layers. For example, any of such layers can be softmax layers, linear layers, pooling layers, or regression layers. In various instances, any of such layers can be coupled together by any suitable interneuron connections or interlayer connections, such as forward connections, skip connections, or recurrent connections. In various aspects, the machine learning models 112 can have the same internal architecture as the central machine learning model 114.

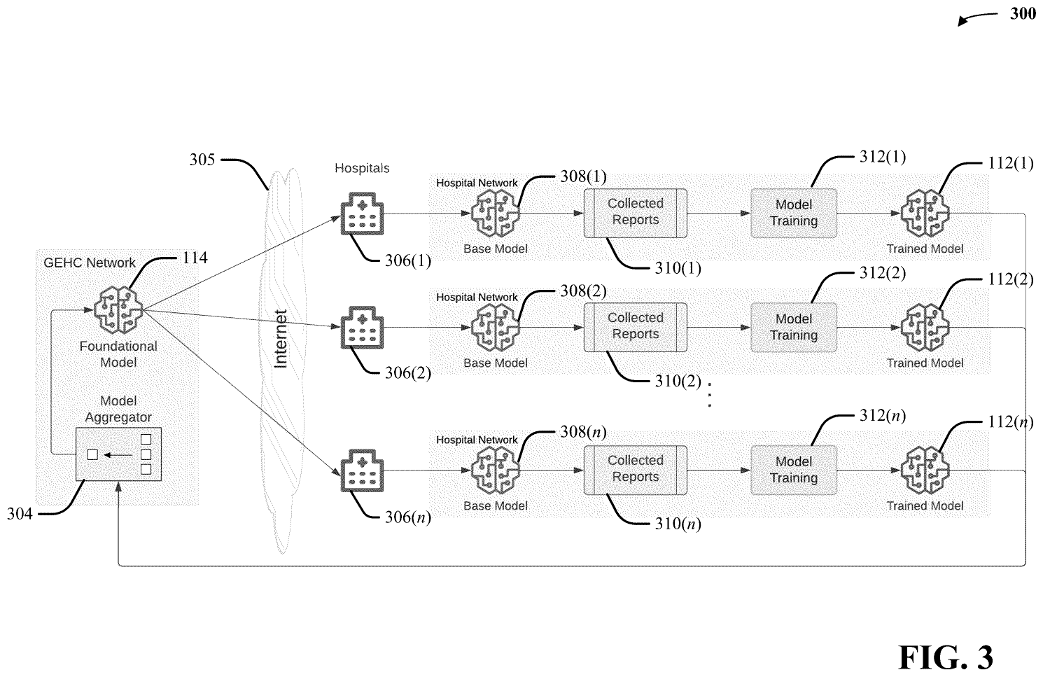

No matter the internal architecture of the central machine learning model 114, the central machine learning model 114 can be configured to perform any suitable NLP task (e.g., text generation, next sentence prediction). In various embodiments, the central machine learning model 114 can be trained via federated training with federated loss functions. Various non-limiting aspects are described with respect to FIGS. 3-7.

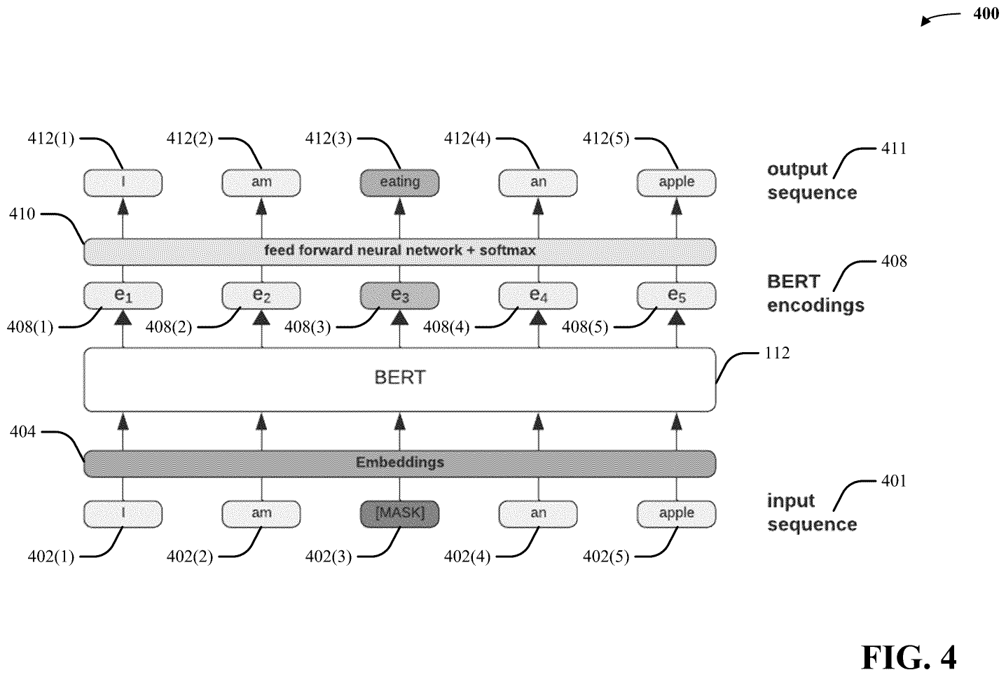

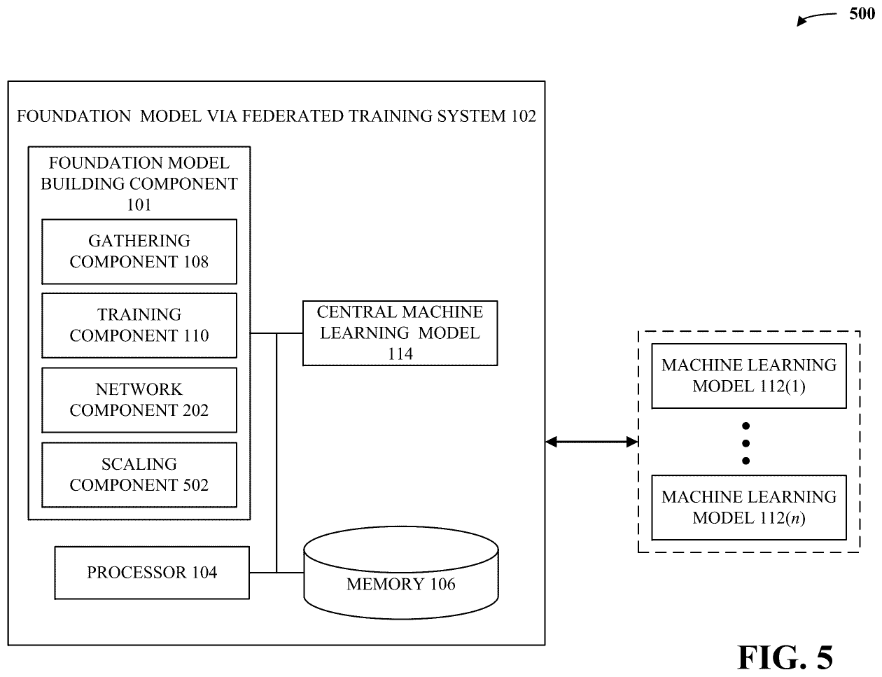

In various embodiments, the machine learning models 112 can be executed on the local data of their respective healthcare institutions, thereby yielding encodings of an output sequence. In various aspects, the machine learning models 112 can be pre-trained using Masked Language Modeling (MLM). MLM is a pre-training objective where random words of an input sequence are masked or replaced with special tokens, and the model is trained to predict the masked or replaced tokens based on context provided by surrounding tokens. Various non-limiting aspects are described with respect to FIGS. 4 and 5.

In various aspects, and as mainly described in the herein disclosure, the central machine learning model 114 can be considered a foundational model (e.g., a machine learning model trained on a large volume of diverse data to that can be specialized for specific tasks). In various instances, and as mainly described in the herein disclosure, the central machine learning model 114 and the machine learning models 112 can be NLP models (e.g., machine learning models that processes and understands human language).

Note that, in order for the machine learning models 112 described herein to be accurate or reliable, the machine learning models 112 should undergo training. Accordingly, the computerized tool described herein can comprise training component 110 that can facilitate such training in any suitable fashion (e.g., supervised fashion, unsupervised fashion, reinforcement learning fashion).

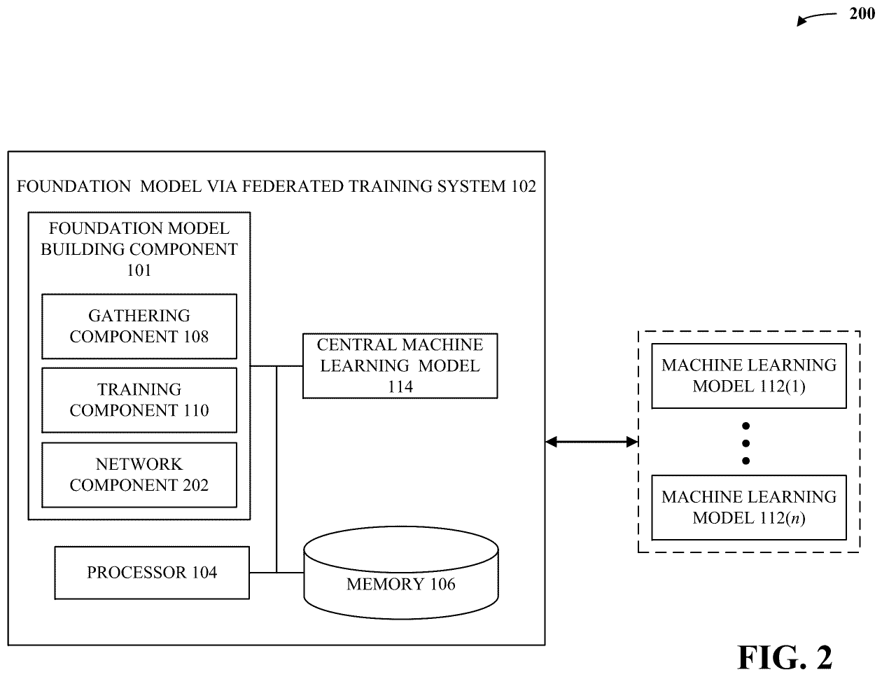

FIG. 2 illustrates a block diagram of an example, non-limiting system 200 including a network component that facilitates aggregation of models in the form of federated loss functions for building the central machine learning model via federated training in accordance with one or more embodiments described herein. As shown, the system 200 can, in some cases, comprise the same components as the system 100, and can further comprise a network component 202. In various embodiments, the sub-components of the foundation model building component 101 can further comprise the network component 202.

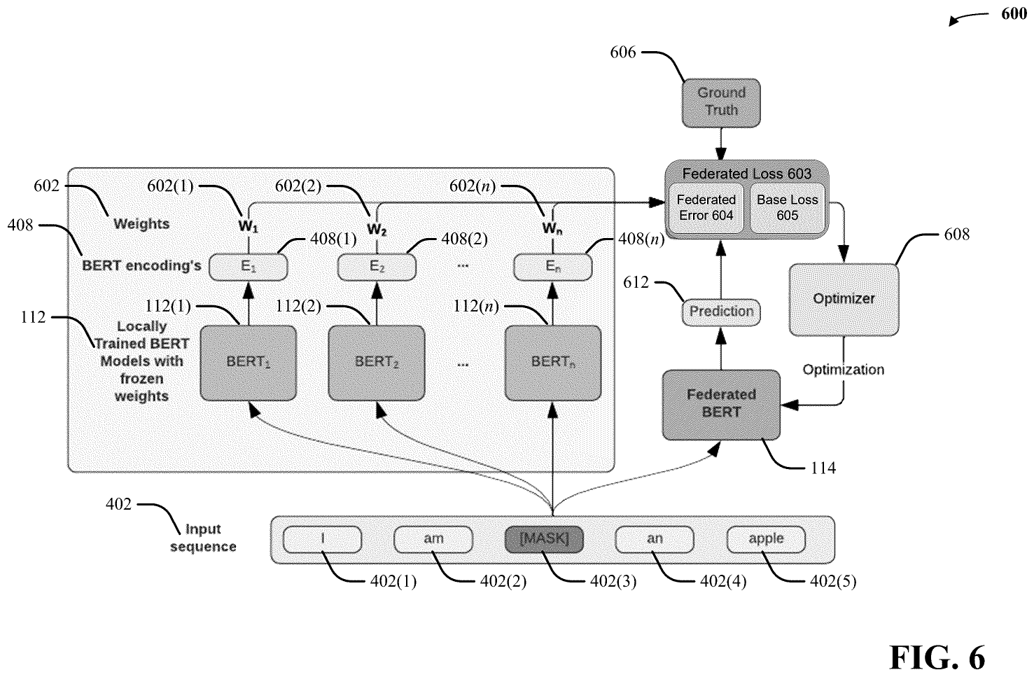

In various embodiments, the network component 202 can electronically retrieve or otherwise electronically obtain the machine learning models 112, and thus the training component 110 can, through the network component 202, utilize the machine learning models 112 to facilitate training of the central machine learning model 114. In various aspects, the network component 202 can share the base model of the central machine learning model 114 with one or more healthcare institutions. Therefore, the base model of the central machine learning model 114 can act as the base model for the machine learning models 112 of the respective healthcare institutions to enable aggregation of the machine learning models 112 after training. For example, if the central machine learning model 114 comprises a base model with BERT model architecture, the network component 202 can share the base model with BERT model architecture with the one or more healthcare institutions. Accordingly, the shared base model can be locally trained within each respective healthcare institution to form the locally trained machine learning models 112. Non-limiting aspects are described with respect to FIGS. 3 and 6.

FIG. 3 illustrates an example, non-limiting block diagram 300 that facilitates federated training of a central machine learning model in accordance with one or more embodiments described herein.

In various embodiments, the network component 202 can share a base model 308 of the central machine learning model 114 to one or more healthcare institutions 306. In various aspects, the healthcare institutions 306 can comprise n healthcare institutions: a healthcare institution 306(1) to a healthcare institution 306(n). In various cases, each of the machine learning models 112 can correspond to a healthcare institution of the healthcare institutions 306. In various embodiments, the network component 202 can share the base model 308 to networks of the one or more healthcare institutions 306 via any suitable communication method. For instance, the network component 202 can share the base model 308 to the networks of the one or more healthcare institutions 306 via internet 305. Accordingly, the base model 308 can be locally trained on data collected from the respective healthcare institutions 306 to form trained machine learning models 112. For example, base model 308(2) in connection with healthcare institution 306 2) can be trained on collected reports 310(2), where collected reports 310(2) can comprise any clinical reports collected from healthcare institution 306(2). As shown by 312(2), the base model 308 can be trained on the collected reports 310(2) to form trained machine learning model 112(2). In various aspects, any suitable training method can be used to train the base model 308 within the respective healthcare institutions 306. In various aspects, the machine learning models 112 can undergo model training 312 in any suitable fashion (e.g., supervised fashion, unsupervised fashion, reinforcement learning fashion). Furthermore, in various cases, model training 312 of the machine learning models 112 can comprise asynchronous training. In other words, the machine learning models 112 do not have to be trained simultaneously.

In various instances, the training component 110 can initialize the base model 308 of the central machine learning model 114. In various embodiments, the machine learning models 112 can, after training, be aggregated by gathering component 108. Accordingly, the training component 110 can update parameters of the central machine learning model 114 based on an optimization of the federated loss computed from the machine learning models 112 after aggregation. Various non-limiting aspects are described herein with respect to FIGS. 5-6. In some instances, the central machine learning model 114 can be pre-trained on any suitable open-source training datasets.

FIG. 4 illustrates an example, non-limiting block diagram 400 that facilitates generating encodings based on an input sequence in accordance with one or more embodiments described herein.

As shown, in various cases, the central machine learning model 114 and the machine learning models 112 can exhibit a BERT model architecture. In various embodiments, the machine learning models 112 can be executed on local data of their respective healthcare institution, and such execution can cause the machine learning models 112 to produce output sequences. More specifically, the local data can be fed as embeddings to a transformer block of the machine learning models 112.

As shown, an input sequence 401 can be, in various aspects, tokenized to generate tokens 402 (e.g., token 402(1), token 402(2), token 402(3), token 402(4), token 402(5)). In various embodiments, one or more tokens of the tokens 402 can be masked. As shown, for example, token 402(3) can be masked with a ‘[MASK]’ token. In various aspects, the one or more tokens to be masked can be selected randomly. In various instances, the tokens 402 can be converted into embeddings 404. For instance, for any positive integer i≤n, an machine learning model 112(i) of the machine learning models 112 can map each token of the tokens 402 to a vector representation in an embedding layer (e.g., matrix where each row corresponds to a vector representation of a token in the vocabulary).

In various embodiments, the embeddings 404 can complete a forward pass through one or more transformer encoder blocks of the machine learning model 112(i). In various instances, an output layer of the central machine learning model 114 can generate one or more encodings 408 (e.g., encoding 408(1), encoding 408(2), encoding 408(3), encoding 408(4), encoding 408(5)) based on final hidden states of the tokens 402 (e.g., output representations of the tokens 402 after passing through the transformer encoder blocks).

In various aspects, the one or more encodings 408 can be any suitable electronic data exhibiting any suitable format, size, or dimensionality. That is, the one or more encodings 408 can be one or more scalars, one or more vectors, one or more matrices, one or more tensors, one or more character strings, or any suitable combination thereof.

As shown by 410, the one or more encodings 408 can be, in various embodiments, fed to an input layer of a feed forward neural network of the transformer encoder blocks. In some aspects, the one or more encodings 408 can complete a forward pass through one or more hidden layers of the feed forward neural network. In various instances, an output layer of the feed forward neural network can produce final representations of the tokens 402. In various aspects, the final representations can be any suitable electronic data exhibiting any suitable format, size, or dimensionality. That is, the final representations can be one or more scalars, one or more vectors, one or more matrices, one or more tensors, one or more character strings, or any suitable combination thereof. In various embodiments, the final representations can complete a forward pass through a softmax layer to apply a softmax function to obtain a probability distribution. Accordingly, the output layer can generate an output sequence 411. The output sequence can comprise predictions of the one or more masked tokens. For instance, output sequence 411 can comprise tokens 412 (e.g., token 412(1), token 412(2), token 412(3), token 412(4), token 412(5)), where token 412(3) is the generated prediction of the masked token 402(3).

For example, as shown, the input sequence 401 can comprise the following tokens: ‘I’, ‘am’, ‘eating’, ‘an’, and ‘apple’. The token ‘eating’ can be masked and replaced with a ‘[MASK]’ token. The tokens (e.g., the input sequence with the masked token) can be converted into embeddings 404, which complete a forward pass through the transformer encoder blocks of machine learning model 112(i) to generate the one or more encodings 408. The one or more encodings 408 can then complete a forward pass through the feed forward neural network and a softmax layer to produce the output sequence 411 with a prediction for the masked token. For instance, as shown, the output sequence 411, comprising the tokens ‘I’, ‘am’, ‘eating’, ‘an’, and ‘apple’, accurately predicts the masked token.

Note that, in order for the machine learning model(i) 112 described herein to be accurate or reliable, the machine learning model(i) 112 should undergo training. Accordingly, the computerized tool described herein can comprise training component 110 that can facilitate such training in any suitable fashion (e.g., supervised fashion, unsupervised fashion, reinforcement learning fashion).

FIG. 5 illustrates a block diagram of an example, non-limiting system 500 including a scaling component that facilitates aggregation of models in the form of federated loss functions for building the central machine learning model via federated training in accordance with one or more embodiments described herein. As shown, the system 500 can, in some cases, comprise the same components as the system 200, and can further comprise a scaling component 502. In various embodiments, the sub-components of the foundation model building component 101 can further comprise the scaling component 502.

In various embodiments, the scaling component 502 can weight the federated error based on characteristics of the training data or the respective healthcare institution of the machine learning models 112. More specifically, the scaling component 502 can weight the one or more encodings 408 generated by the machine learning models 112. In particular, the one or more encodings 408 of the masked tokens input into the machine learning models 112 can be weighted. In various aspects, the scaling component 502 can weight the one or more encodings 408 based on a volume of training data used to train the machine learning models 112. In various cases, the scaling component 502 can assign weights to be directly proportional to the volumes of the training data. For instance, if machine learning model 112(1) was trained on a dataset thrice in size of a dataset from which machine learning model 112(2) is trained, the scaling component 502 can assign a weight of 0.75 to encoding 408(1) and a weight of 0.25 to encoding 408(2). Note that, this is a mere non-limiting example for ease of explanation and any suitable weights can be assigned to the one or more encodings 408 that reflect the volume of training data of each of the machine learning models 112.

In various instances, the scaling component 502 can weight the one or more encodings 408 based on geographical locations of the respective healthcare institutions 306 according to user preferences. In some cases, it can be desirable to tailor or specialize the central machine learning model 114 to a particular geographic location (e.g., a country, a city, a region) to provide enhanced generalization to a particular population. Accordingly, the scaling component 502 can assign weights based on the desired geographical location. For instance, if it is desirable to train and specialize the central machine learning model 114 to a specific city, the scaling component 502 can assign higher weights to encodings generated by machine learning models 112 in connection with respective healthcare institutions located in that specific city than encodings generated by machine learning models 112 in connection with respective healthcare institutions not located in that specific city.

In various embodiments, the scaling component 502 can weight the one or more encodings 408 based on functionalities of the respective healthcare institutions 306. In some cases, it can be desirable to tailor or specialize the central machine learning model 114 to a particular healthcare field. For example, if it is desirable to specialize the central machine learning model 114 for medical research, the scaling component 502 can assign higher weights to encodings generated by machine learning models 112 in connection with healthcare institutions that perform medical research than encodings generated by machine learning models 112 in connection with healthcare institutions that do not perform medical research. As another example, if it is desirable to specialize the central machine learning model 114 to oncology, the scaling component 502 can assign higher weights to encodings generated by machine learning models 112 in connection with healthcare institutions that specialize in oncology than encodings generated by machine learning models 112 in connection with healthcare institutions that do not specialize in oncology.

FIG. 6 illustrates an example, non-limiting block diagram 600 that facilitates aggregation of models in the form of federated loss functions for building the central machine learning model via federated training in accordance with one or more embodiments described herein.

In various embodiments, the input sequence 401 can be input into the central machine learning model 114 and the machine learning models 112. In various aspects, the machine learning models can generate one or more encodings 408 based on the input sequence 401. Additionally, the central machine learning model 114 can generate an encoding of a prediction 612 based on the input sequence 401. Various non-limiting aspects of how the machine learning models 112 and the central machine learning model 114 can generate such encodings and prediction are described with reference to FIG. 4.

In various aspects, the scaling component 502 can assign weights 602 to the one or more encodings 408 generated based on various characteristics of the machine learning models 112. For example, the weights 602 can be assigned based on geographical location of the respective healthcare institution. In other cases, the weights 602 can be assigned based on training data size of the machine learning models 112. In some instances, the weights 602 can be assigned based on a desired field of interest for specializing the central machine learning model to such desired field of interest. In various aspects, the weights 602 can be assigned based on any suitable combination of any of the aforementioned.

In various aspects, the training component 110 can compute a federated error 604 and base loss 605 based on the weighted one or more encodings 408, the encoding of a prediction 612, and a ground truth 606 of the input sequence 401. In various instances, the base loss 605 can be an error between the ground-truth 606 and the encoding of a prediction 612 generated by the central machine learning model 114. In various aspects, the training component 110 can compute the base loss 605 by any suitable method based on the task of the central machine learning model 114 or nature of the data (e.g., cross-entropy loss, mean squared error, triplet loss, cosine similarity loss, hinge loss). For instance, the training component 110 can compute the base loss 605 as a cross-entropy loss (e.g., measure of similarity between two probability distributions) by transforming a probability distribution of the ground truth 606 and the encoding of a prediction 612 into one-hot encodings (e.g., binary vector representations where each word is uniquely represented by a vector with a single “on” (1) value at its corresponding index position and all other positions set to “off” (0)). Therefore, the cross-entropy loss can be computed between the binary vector representation of the ground-truth 606 and the encoding of a prediction 612. More specifically, the base loss 605 can be computed from the following equation:

$$l = {\sum }_{i = 0}^{n} {y}_{i} log ( {p}_{i} )$$

where l denotes the base loss 605, p denotes a predicted probability, y denotes the actual distribution, and n is the number of tokens in the vocabulary.

In various embodiments, the training component 110 can compute the federated error 604. In various aspects, the federated error 604 can be an error between the encoding of a prediction 612 and the one or more encodings 408 generated by the machine learning models 112. More specifically, the federated error 604 can be the distance between the encoding of a prediction 612 and the one or more encodings 408 generated by the machine learning models 112 in terms of an evaluation metric. In various cases, any suitable evaluation metric can be used to compute the federated error 604 (e.g., root mean squared error (RMSE), cosine similarity, Euclidean distance). For instance, an RMSE of machine learning model 112(i) trained locally within healthcare institution 306(i) between the encoding of a prediction 612 and the one or more encodings 408 generated by the machine learning models 112 can be computed from the following equation:

$${E}_{r i} = \frac{1}{k} \sqrt{{\sum }_{i = 1}^{k} {( {e}_{i} - \hat{e} )}^{2}}$$

where Eᵣᵢ denotes the RMSE from machine learning model 112(i) collected from healthcare institution 306(i), e denotes the encoding 408(i) (e.g., the encoding generated by the i-th machine learning model), ê denotes the encoding of a prediction 612 generated by the central machine learning model 114, and k denotes the number of dimensions in the encodings. In various instances, the training component 110 can compute a weighted average of the federated error 604 if the respective healthcare institutions comprise more than one healthcare institutions. In various cases, to apply the weights 602 assigned to the encodings 408, the RMSE of machine learning model 112(i) can be defined by Eᵢ=wEᵣᵢ, where w denotes the weight (e.g., weight 602(i)) assigned to the machine learning model 112(i).

In various embodiments, the training component 110 can compute an average of the RMSE of each of the machine learning models 112 to determine the federated error 604. In other cases, if another evaluation metric is utilized, the training component 110 can compute an average of the selected evaluation metric of each of the machine learning models 112 to determine the federated error 604.

In various instances, the training component 110 can generate a sum of the federated error 604 (e.g., weighted average of the federated error 604) and the base loss 605 to determine a federated loss function 603 (e.g., L_{f}=l+E, where E denotes the federated error 604). In various aspects, for an evaluation metric of RMSE, the federated loss function 603 can be defined by the following equation:

$${L}_{f} = {\sum }_{i = 0}^{n} {y}_{i} log ( {p}_{i} ) + \frac{1}{m} {\sum }_{j = 1}^{m} {w}_{j} {E}_{r j}$$

where n denotes the number of tokens in the vocabulary, m denotes the number of healthcare institutions, and Eᵣⱼ denotes the error between encoding 408(j) generated by the machine learning model 112(j) and the encoding of a prediction 612 generated by the central machine learning model 114. In various embodiments, the training component 110 can optimize, as shown by 608, the federated loss function 603 with any suitable optimization techniques (e.g., stochastic gradient descent, adaptive moment estimation, root mean square propagation).

In various embodiments, the training component 110 can update, via backpropagation, parameters of the central machine learning model 114 based on the optimization of the federated loss function 603 that comprises the federated error 604 and the base loss 605. In various aspects, backpropagation can comprise computing a gradient of the federated loss function 603 with respect to each parameter of the central machine learning model 114. Accordingly, the computed gradient is utilized to update the parameter of the central machine learning model 114 in a direction that minimizes the federated loss function 603. In various aspects, the central machine learning model 114 can be iteratively updated via backpropagation for one or more training datasets.

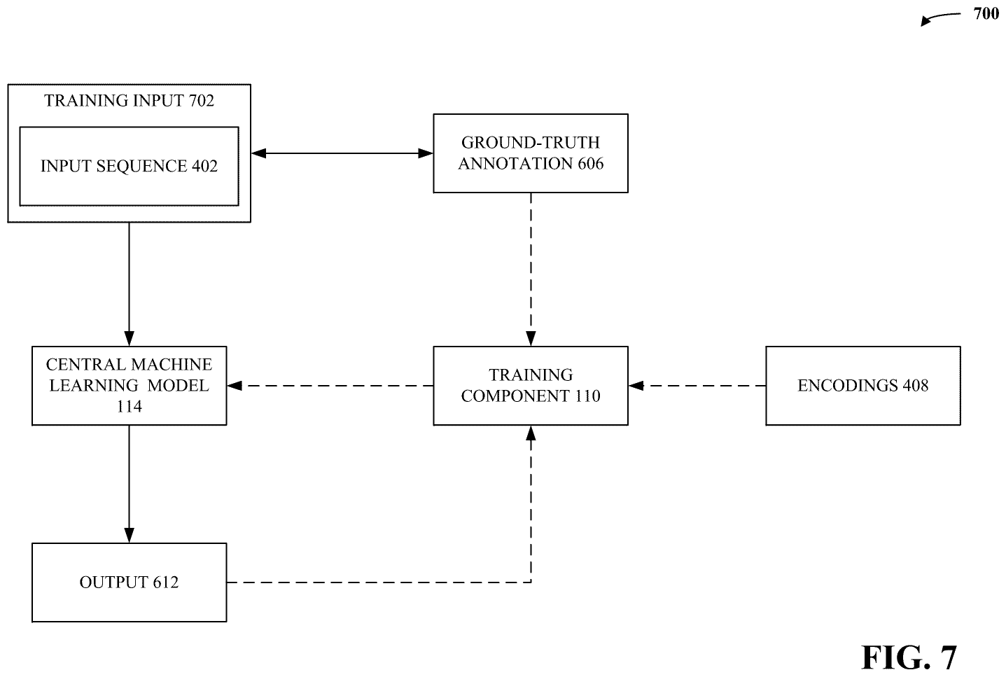

FIG. 7 illustrates an example, non-limiting block diagram 700 that facilitates training of a central machine learning model in accordance with one or more embodiments described herein.

In various aspects, prior to beginning training, the training component 110 can initialize in any suitable fashion (e.g., via random initialization) trainable internal parameters (e.g., convolutional kernels, weight matrices, bias values) of the central machine learning model 114.

In various embodiments, there can be a training input 702 and ground-truth annotation 606. When it is desired to train the central machine learning model 114, the training input 702 can comprise input sequence 401. In various aspects, the input sequence 401 can comprises masked tokens. The ground-truth annotation 606 can be the input sequence 401 without masked tokens that is known or deemed to correspond to the training input 702. Note that, if the central machine learning model 114 has so far undergone no or little training, then the output 612 can be highly inaccurate. In other words, the output 612 can be very different from the ground-truth annotation 606.

In various aspects, the training component 110 can execute the central machine learning model 114 on the training input 702, thereby causing the central machine learning model 114 to produce an output 612 (e.g., encoding of a prediction 612). More specifically, in some cases, the training component 110 can feed or route the training input 702 to an input layer of the central machine learning model 114, the training input 702 can complete a forward pass through the one or more transformer encoder blocks of the central machine learning model 114, and the output layer of the central machine learning model 114 can compute the output 612.

Note that the format, size, or dimensionality of the output 612 can be dictated by the number, arrangement, sizes, or other characteristics of the neurons, convolutional kernels, or other internal parameters of the output layer (or of any other layers) of the central machine learning model 114. Accordingly, the output 612 can be forced to have any desired format, size, or dimensionality, by adding, removing, or otherwise adjusting characteristics of the output layer (or of any other layers) of the central machine learning model 114.

In various aspects, the training component 110 can compute an error (e.g., mean absolute error (MAE), mean squared error (MSE), cross-entropy error) between the output 612 and the ground-truth annotation 606. Such an error can be considered the base loss 605, as previously described with respect to FIG. 6. In various embodiments, the training component 110 can compute the federated error 604 between the output 612 and the one or more encodings 408. In various aspects, the training component 110 can compute the federated loss function 603 that comprises the base error and the federated error. The federated loss function 603 can be computed and optimized using methods previously described with respect to FIG. 6. In various instances, the training component 110 can incrementally update the trainable internal parameters of the central machine learning model 114, via backpropagation (e.g., stochastic gradient descent) based on the optimized federated loss function 603.

In various cases, such execution-and-update procedure can be repeated for any suitable number of input-annotation pairs. This can ultimately cause the trainable internal parameters of the central machine learning model 114 to become iteratively optimized for accurately generating output that matches the ground-truth annotation 606. In various aspects, the training component 110 can utilize any suitable training batch sizes, any suitable error/loss functions, or any suitable training termination criteria.

Although the herein disclosure mainly describes the central machine learning model 114 as being trained in supervised fashion, this is a mere non-limiting example for ease of explanation and illustration. In various embodiments, any other suitable training paradigm can be used to train the central machine learning model 114, such as unsupervised training or reinforcement learning.

Furthermore, although the herein disclosure mainly describes the central machine learning model 114 and the machine learning models 112 as comprising a BERT-based architecture with MLM, this is a mere non-limiting example for ease of explanation and illustration. In various embodiments, the central machine learning model 114 and the machine learning models 112 can comprise any other suitable NLP model architecture (e.g., flan t5, GPT series, llama).

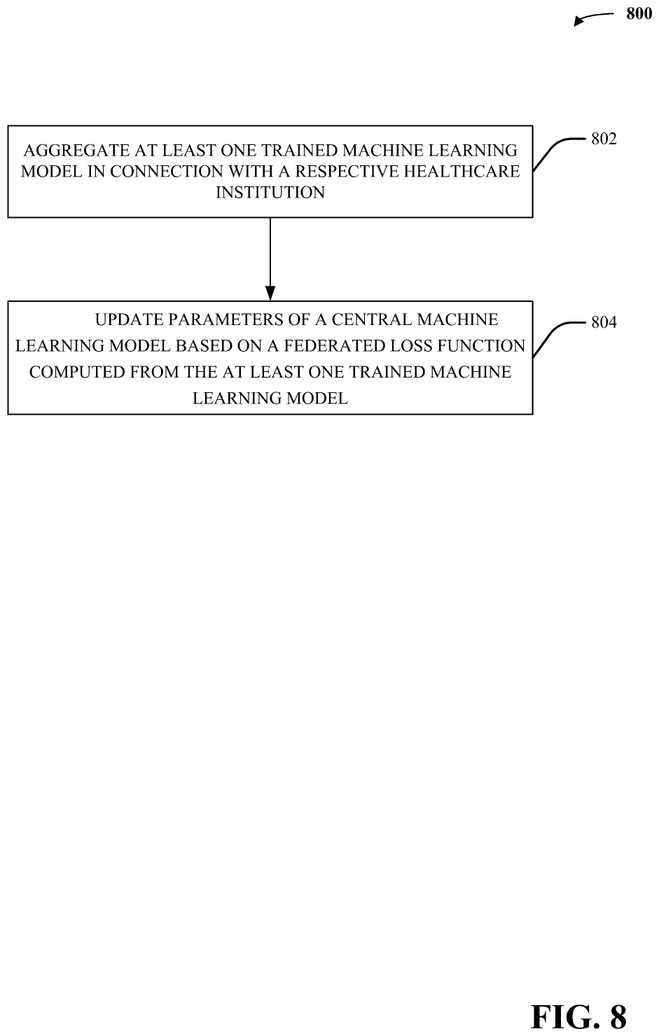

FIG. 8 illustrates a flow diagram of an example, non-limiting computer-implemented method 800 that facilitates aggregation of models in the form of federated loss functions for building the central machine learning model via federated training in accordance with one or more embodiments described herein.

In various embodiments, act 802 can include aggregating, by a device (e.g., via 108) operatively coupled to a processor (e.g., 104), at least one trained machine learning model (e.g., 112) in connection with a respective healthcare institution (e.g., 306). In various aspects, the at least one trained machine learning model can be locally trained within the respective healthcare institution.

In various embodiments, act 804 can include updating, by the device (e.g., via 110), parameters of a central machine learning model (e.g., 114) based on a federated loss function (e.g., 603) computed from the at least one machine learning model.

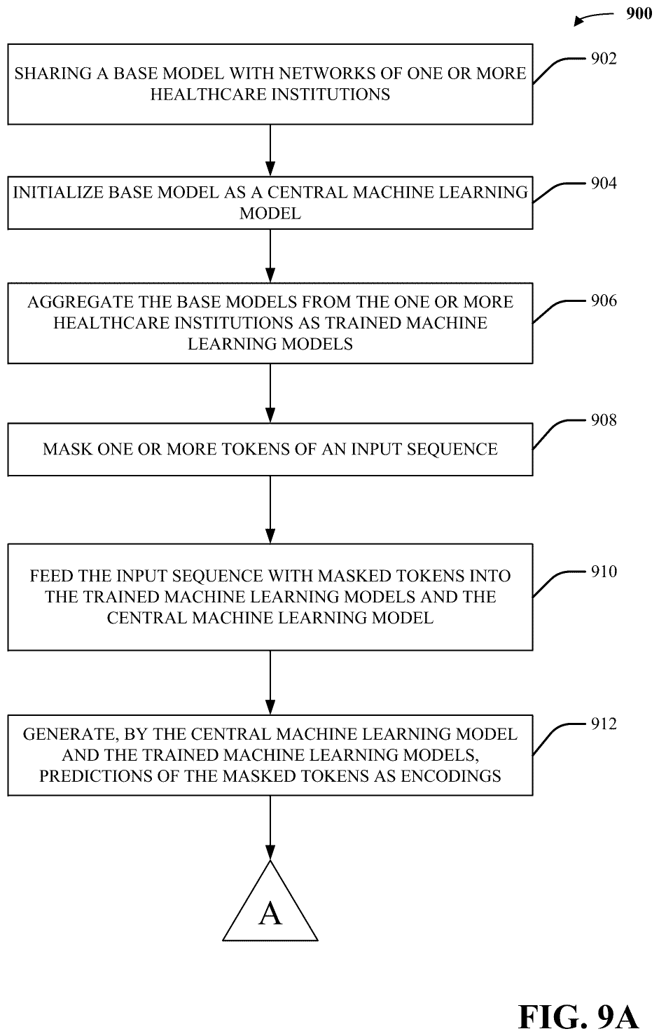

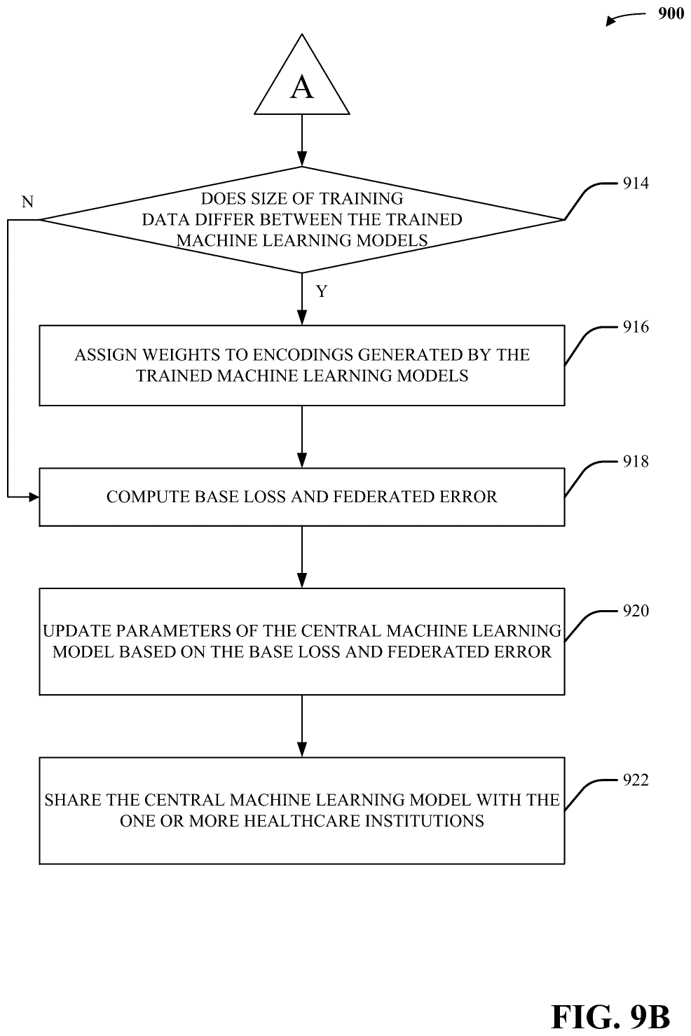

FIGS. 9A and 9B illustrate a flow diagram of an example, non-limiting computer-implemented method 900 that facilitates aggregation of models in the form of federated loss functions for building the central machine learning model via federated training in accordance with one or more embodiments described herein.

In various embodiments, act 902 can include sharing, by a device (e.g., via 202) operatively coupled to a processor (e.g., 112), a base model (e.g., 308) with networks of one or more healthcare institutions (e.g., 306).

In various aspects, act 904 can include initializing, by the device (e.g., via 110), the base model as a central machine learning model (e.g., 114).

In various aspects, act 906 can include aggregating, by the device (e.g., via 108), base models from the one or more healthcare institutions as trained machine learning models (e.g., 112). In other words, the network component 202 can receive the trained machine learning models 112. In various instances, the base model 308 can be shared and the trained machine learning models 112 can be returned via any suitable communication methods (e.g., internet) and via any suitable format (e.g., .h5 file format). In various cases, the machine learning models 112 can be fine-tuned before being received by the network component 202. More specifically, the machine learning models 112 can be further trained to any suitable domain or task with any suitable task-specific data.

In various cases, act 908 can include masking, by the device (e.g., via 110), one or more tokens (e.g., 402) of an input sequence (e.g., 401).

In various aspects, act 910 can include feeding, by the device (e.g., via 110), the input sequence with masked tokens into the trained machine learning models and the central machine learning model.

In various aspects, act 912 can include generating, by the device (e.g., via 110) and by the central machine learning model and the machine learning models, predictions of the masked tokens as encodings (e.g., 408).

In various instances, act 914 can include determining, by the device (e.g., via 502), whether the size of training data differs between the trained machine learning models. If so, the computer-implemented method 900 can proceed to act 916. If not, the computer-implemented method 900 can instead proceed to act 918.

In various aspects, act 916 can include assigning, by the device (e.g., via 502), weights (e.g., 602) to the encodings generated by the trained machine learning models. In various aspects, the scaling component 502 can further assign weights 602 to the encodings 408 based on any other suitable characteristics of the machine learning models 112 or respective healthcare institutions 306. For instance, the scaling component 502 can assign weights 602 based on geographic location or a desired field of interest (e.g., type of healthcare institution, healthcare institutions specializing in radiology) of the respective healthcare institutions 306.

In various aspects, act 918 can include computing, by the device (e.g., via 110), a base loss (e.g., 605) and a federated error (e.g., 604).

In various aspects, act 920 can include updating, by the device (e.g., via 110), parameters of the central machine learning model based on the base loss and federated error. In various aspects, the training component 110 can update parameters of the central machine learning model 114 based on a sum of the federated error 604 and the base loss 605.

In various aspects, act 922 can include sharing, by the device (e.g., via 202), the central machine learning model with the one or more healthcare institutions. In various aspects, the network component 202 can share, via any suitable communication method or format, the central machine learning model 114 with the networks of the one or more healthcare institutions to enable enhancement of the locally trained machine learning models 112. In various instances, such a process can be iterated any number of times. More specifically, after updating the parameters of the central machine learning model 114 and sharing the updated central machine learning model 114 with the locally trained machine learning models 112, the machine learning models 112 can be aggregated again after retraining or updating. Accordingly, the central machine learning model 114 can be further enhanced by updating parameters based on an optimization of a federated loss of the retrained machine learning models 112.

For example, there can be different healthcare institutions that specialize in different areas such as cardiology, neurology, and oncology respectively. Each of the healthcare institutions can train its own machine learning model on its local patient data to predict diseases specific to its specialty. For instance, the healthcare institution specializing in cardiology trains machine learning model to predict heart diseases based on patient demographics, medical history, and diagnostic tests. After training the machine learning models for each respective healthcare institution, parameters of the central machine learning model 114 can be updated based on an optimization of the federated loss function that is determined based on the aggregation of the machine learning models 112. Thus, the central machine learning model 114 can learn insights from various medical domains (e.g., cardiology, neurology, oncology) and become more robust and accurate in predicting a range of diseases. The updated central machine learning model 114 can then be shared, via network component 202, back with the healthcare institutions to enhance the machine learning models 112. For instance, the cardiology hospital receives the updated central machine learning model 114, which incorporates insights from neurology and oncology, thereby improving its ability to detect and diagnose cardiovascular diseases accurately. By leveraging federated training and sharing the central machine learning model 114, the respective healthcare institutions can collectively benefit from a more comprehensive and accurate disease prediction and diagnosis system, leading to earlier detection, personalized treatment plans, and improved patient outcomes across various medical specialties.

As another example, the respective healthcare institutions can comprise different research organizations that conduct studies and experiments to identify potential drug candidates for various diseases, wherein each healthcare institution utilizes its respective proprietary datasets to train the machine learning models 112 for drug discovery tasks (e.g., molecular structure analysis, drug-target interactions, toxicity prediction). After updating parameters of the central machine learning model 114 based on the optimization of the federated loss function and sharing the central machine learning model 114 with the respective research organizations, the machine learning models 112 can be enhanced with collective intelligence of the different research organizations without sharing the proprietary datasets. For instance, by leveraging such federated training, the different research organizations can streamline drug discovery processes, reduce research redundancies, and expedite delivery of safe and effective treatments to patients.

In order for the foundation model via federated training system 102 to function accurately, correctly, or reliably, the central machine learning model 114 and the machine learning models 112 can first undergo training, as described with respect to FIGS. 3-7.

In various instances, machine learning algorithms or models can be implemented in any suitable way to facilitate any suitable aspects described herein. To facilitate some of the above-described machine learning aspects of various embodiments, consider the following discussion of artificial intelligence (AI). Various embodiments described herein can employ artificial intelligence to facilitate automating one or more features or functionalities. The components can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein, components described herein can examine the entirety or a subset of the data to which it is granted access and can provide for reasoning about or determine states of the system or environment from a set of observations as captured via events or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events or data.

Such determinations can result in the construction of new events or actions from a set of observed events or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes or systems (e.g., support vector machines, neural networks, expert systems, Bayesian belief networks, fuzzy logic, data fusion engines, and so on) in connection with performing automatic or determined action in connection with the claimed subject matter. Thus, classification schemes or systems can be used to automatically learn and perform a number of functions, actions, or determinations.

A classifier can map an input attribute vector, z=(z₁, z₂, z₃, z₄, zₙ), to a confidence that the input belongs to a class, as by f(z)=confidence(class). Such classification can employ a probabilistic or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, or probabilistic classification models providing different patterns of independence, any of which can be employed. Classification as used herein also is inclusive of statistical regression that is utilized to develop models of priority.

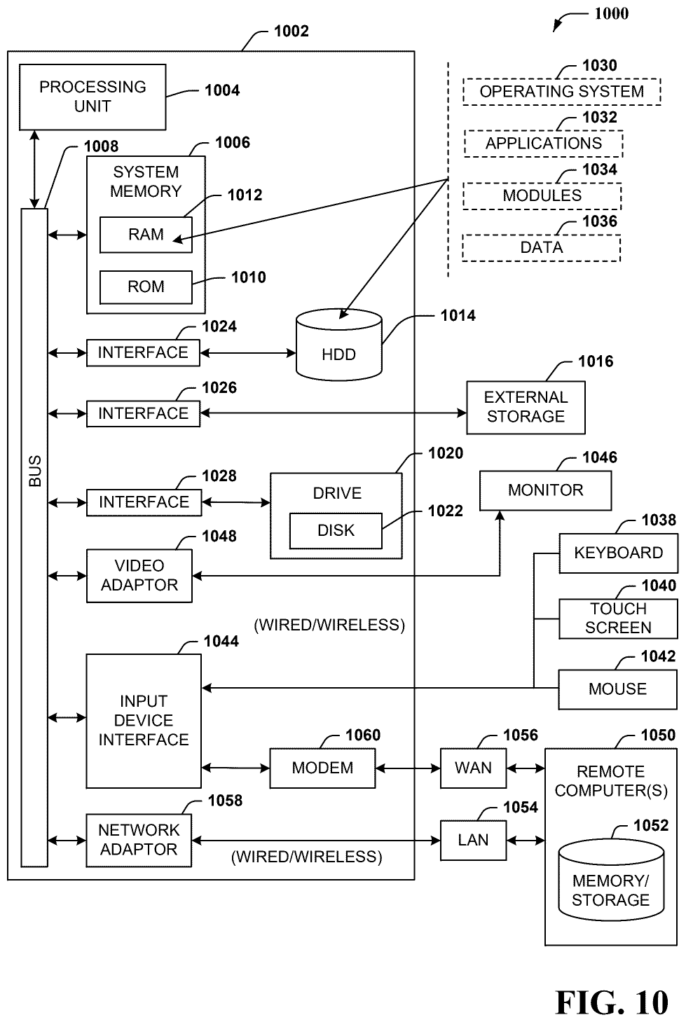

In order to provide additional context for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multi-processor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and a drive 1020, e.g., such as a solid state drive, an optical disk drive, which can read or write from a disk 1022, such as a CD-ROM disc, a DVD, a BD, etc. Alternatively, where a solid state drive is involved, disk 1022 would not be included, unless separate. While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and drive 1020 can be connected to the system bus 1008 by an HDD interface 1024, an external storage interface 1026 and a drive interface 1028, respectively. The interface 1024 for external drive implementations can include at least one or both of Universal Serial Bus (USB) and Institute of Electrical and Electronics Engineers (IEEE) 13104 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enable with a security module, such as a trusted processing module (TPM). For instance with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 13104 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above, such as but not limited to a network virtual machine providing one or more aspects of storage or processing of information. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

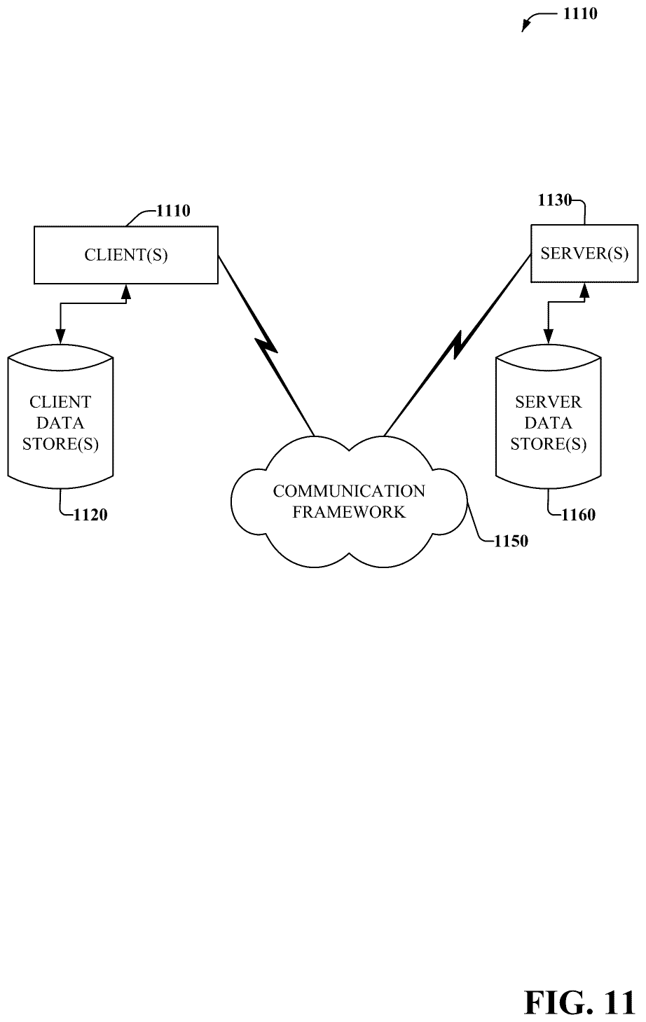

FIG. 11 is a schematic block diagram of a sample computing environment 1100 with which the disclosed subject matter can interact. The sample computing environment 1100 includes one or more client(s) 1110. The client(s) 1110 can be hardware or software (e.g., threads, processes, computing devices). The sample computing environment 1100 also includes one or more server(s) 1130. The server(s) 1130 can also be hardware or software (e.g., threads, processes, computing devices). The servers 1130 can house threads to perform transformations by employing one or more embodiments as described herein, for example. One possible communication between a client 1110 and a server 1130 can be in the form of a data packet adapted to be transmitted between two or more computer processes. The sample computing environment 1100 includes a communication framework 1150 that can be employed to facilitate communications between the client(s) 1110 and the server(s) 1130. The client(s) 1110 are operably connected to one or more client data store(s) 1120 that can be employed to store information local to the client(s) 1110. Similarly, the server(s) 1130 are operably connected to one or more server data store(s) 1140 that can be employed to store information local to the servers 1130.

Various embodiments may be a system, a method, an apparatus or a computer program product at any possible technical detail level of integration. The computer program product can include a computer readable storage medium (or media) having computer readable program instructions thereon for causing a processor to carry out aspects of various embodiments. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of various embodiments can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform various aspects.

Various aspects are described herein with reference to flowchart illustrations or block diagrams of methods, apparatus (systems), and computer program products according to various embodiments. It will be understood that each block of the flowchart illustrations or block diagrams, and combinations of blocks in the flowchart illustrations or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks. These computer readable program instructions can also be stored in a computer readable storage medium that can direct a computer, a programmable data processing apparatus, or other devices to function in a particular manner, such that the computer readable storage medium having instructions stored therein comprises an article of manufacture including instructions which implement aspects of the function/act specified in the flowchart or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart or block diagram block or blocks.

The flowcharts and block diagrams in the Figures illustrate the architecture, functionality, and operation of possible implementations of systems, methods, and computer program products according to various embodiments. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer or computers, those skilled in the art will recognize that this disclosure also can or can be implemented in combination with other program modules. Generally, program modules include routines, programs, components, data structures, etc. that perform particular tasks or implement particular abstract data types. Moreover, those skilled in the art will appreciate that various aspects can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system, or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter disclosed herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

The herein disclosure describes non-limiting examples. For ease of description or explanation, various portions of the herein disclosure utilize the term “each,” “every,” or “all” when discussing various examples. Such usages of the term “each,” “every,” or “all” are non-limiting. In other words, when the herein disclosure provides a description that is applied to “each,” “every,” or “all” of some particular object or component, it should be understood that this is a non-limiting example, and it should be further understood that, in various other examples, it can be the case that such description applies to fewer than “each,” “every,” or “all” of that particular object or component.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A system, comprising:
a processor that executes computer-executable components stored in a non-transitory computer-readable memory, wherein the computer-executable components comprise:
a gathering component that aggregates at least one trained machine learning model in connection with a respective healthcare institution; and
a training component that updates parameters of a central machine learning model based on an optimization of a federated loss function computed from the at least one trained machine learning model, wherein the federated loss function comprises a federated error and a base loss.

2. The system of claim 1, further comprising:
a scaling component that weights the federated error based on volume of training data of each of the at least one trained machine learning model.

3. The system of claim 2, wherein the scaling component weights, according to user preference, the federated error based on geographic location of the respective healthcare institution.

4. The system of claim 1, further comprising
a network component that shares the central machine learning model after updating the parameters based on the optimization of the federated loss function with the at least one trained machine learning model.

5. The system of claim 1, wherein training datasets utilized to train the at least one trained machine learning model comprises protected health information (PHI) reports, patient records, clinical notes, lab results, imaging reports, medication histories, or relevant clinical textual information from the respective healthcare institution.

6. The system of claim 1, wherein the training component updates the parameters of the central machine learning model, via backpropagation, based on the optimization of the federated loss function.

7. The system of claim 1, wherein the at least one trained machine learning model and the central machine learning model receives an input sequence, wherein the at least one trained machine learning model outputs one or more encodings of a prediction based on the input sequence and the central machine learning model outputs an encoding of another prediction based on the input sequence, and wherein the federated error is an error between the encoding generated from the central machine learning model and the one or more encodings generated from the at least one trained machine learning model.

8. The system of claim 7, wherein the base loss is an error between the encoding generated from the central machine learning model and a ground-truth.

9. The system of claim 2, wherein weights of the federated error are directly proportional to the volume of training data.

10. The system of claim 1, wherein the training component computes a weighted average of the federated error if the respective healthcare institutions comprise more than one healthcare institution, and wherein a sum of the weighted average and base loss is used to compute the federated loss function.

11. A computer-implemented method, comprising:
aggregating, by a device operatively coupled to a processor, at least one trained machine learning model in connection with a respective healthcare institution; and
updating, by the device, parameters of a central machine learning model based on an optimization of a federated loss function computed from the at least one trained machine learning model, wherein the federated loss function comprises a federated error and a base loss.

12. The computer-implemented method of claim 11, further comprising;
weighting, by the device, the federated error based on volume of training data of each of the at least one trained machine learning model.

13. The computer-implemented method of claim 12, further comprising;
weighting, by the device, the federated error based on geographic location of the respective healthcare institution according to user preference.

14. The computer-implemented method of claim 11, further comprising:
sharing, by the device, the central machine learning model after updating the parameters based on the optimization of the federated loss function with the at least one trained machine learning model.

15. The computer-implemented method of claim 11, wherein training datasets utilized to train the at least one trained machine learning model comprises protected health information (PHI) reports, patient records, clinical notes, lab results, imaging reports, medication histories, or relevant clinical textual information from the respective healthcare institution.

16. The computer-implemented method of claim 11, further comprising:
updating, by the device, the parameters of the central machine learning model, via backpropagation, based on the optimization of the federated loss function.

17. The computer-implemented method of claim 16, wherein the at least one trained machine learning model and the central machine learning model receives an input sequence, wherein the at least one trained machine learning model outputs one or more encodings of a prediction based on the input sequence and the central machine learning model outputs an encoding of another prediction based on the input sequence, and wherein the federated error is an error between the encoding generated from the central machine learning model and the one or more encodings generated from the at least one trained machine learning model.

18. The computer-implemented method of claim 17, wherein the base loss is an error between the encoding generated from the central machine learning model and a ground-truth.

19. A computer program product for tailored loss functions for building healthcare foundation models via federated training, the computer program product comprising a non-transitory computer readable memory having program instructions embodied therewith, the program instructions executable by a processor to cause the processor to:
aggregate at least one trained machine learning model in connection with a respective healthcare institution; and
update parameters of a central machine learning model based on an optimization of a federated loss function computed from the at least one trained machine learning model, wherein the federated loss function comprises a federated error and a base loss.

20. The computer program product of claim 19, wherein the program instructions are further executable by the processor to cause the processor to:
weight the federated error based on volume of training data of each of the at least one trained machine learning model.
